(19) United States
(12) Patent Application Publication
(10) Pub. No.: US 2013/0287218 A1
(43) Pub. Date: Oct. 31, 2013

(54) LEAKAGE-MODELING ADAPTIVE NOISE CANCELING FOR EARSPEAKERS

(71) Applicant: CIRRUS LOGIC, INC., Austin, TX (US)

(72) Inventors: Jeffrey Alderson, Austin, TX (US); Jon D. Hendrix, Wimberly, TX (US)

(73) Assignee: CIRRUS LOGIC, INC., Austin, TX (US)

(21) Appl. No.: 13/692,367

(22) Filed: Dec. 3, 2012

Related U.S. Application Data
(60) Provisional application No. 61/638,602, filed on Apr. 26, 2012.

(51) Int. Cl. G10K 11/00

(52) U.S. Cl. CPC G10K 11/002
USPC 381/71.6

(57) ABSTRACT

A personal audio device, such as a headphone, includes an adaptive noise canceling (ANC) circuit that adaptively generates an anti-noise signal from a reference microphone signal that measures the ambient audio, and the anti-noise signal is combined with source audio to provide an output for a speaker. The anti-noise signal causes cancellation of ambient audio sounds that appear at the reference microphone. A processing circuit uses the reference microphone to generate the anti-noise signal, which can be generated by an adaptive filter. The processing circuit also models an acoustic leakage path from the transducer to the reference microphone and removes elements of the source audio appearing at the reference microphone signal due to the acoustic output of the speaker. Another adaptive filter can be used to model the acoustic leakage path.

This U.S. Patent Application claims priority under 35 U.S.C. 119(e) to U.S. Provisional Patent Application Ser. No. 61/638,602 filed on Apr. 26, 2012.

### BACKGROUND OF THE INVENTION

1. Field of the Invention

The present invention relates generally to personal audio devices such as headphones that include adaptive noise cancellation (ANC), and, more specifically, to architectural features of an ANC system in which leakage from an earspeaker to the reference microphone is modeled.

2. Background of the Invention

Wireless telephones, such as mobile/cellular telephones, cordless telephones, and other consumer audio devices, such as MP3 players, are in widespread use. Performance of such devices with respect to intelligibility can be improved by providing noise canceling using a reference microphone to measure ambient acoustic events and then using signal processing to insert an anti-noise signal into the output of the device to cancel the ambient acoustic events.

When the acoustic path from the transducer to the reference microphone is not highly attenuative, for example when the transducer and reference microphone are included on an earspeaker, or when a telephone-mounted output transducer is not pressed to the user's ear, the ANC system will try to cancel the portion of the playback signal that arrives at the reference microphone.

Therefore, it would be desirable to provide a personal audio device, including a wireless telephone that provides noise cancellation that is effective and/or does not generate undesirable responses when leakage is present from the output transducer to the reference microphone.

### SUMMARY OF THE INVENTION

The above stated objectives of providing a personal audio device having effective noise cancellation when leakage is present, is accomplished in a personal audio system, a method of operation, and an integrated circuit.

The personal audio device includes an output transducer for reproducing an audio signal that includes both source audio for playback to a listener, and an anti-noise signal for countering the effects of ambient audio sounds in an acoustic output of the transducer. The personal audio device also includes the integrated circuit to provide adaptive noise-canceling (ANC) functionality. The method is a method of operation of the personal audio system and integrated circuit. A reference microphone is mounted on the device housing to provide a reference microphone signal indicative of the ambient audio sounds. The personal audio system further includes an ANC processing circuit for adaptively generating an anti-noise signal from the reference microphone signal, such that the anti-noise signal causes substantial cancellation of the ambient audio sounds. An adaptive filter can be used to generate the anti-noise signal by filtering the reference microphone signal. The ANC processing circuit further models an acoustic leakage path from the acoustic output of the output transducer to the reference microphone, and removes elements of the acoustic output appearing at the reference microphone signal. The leakage path modeling may be performed by another adaptive filter.

The foregoing and other objectives, features, and advantages of the invention will be apparent from the following, more particular, description of the preferred embodiment of the invention, as illustrated in the accompanying drawings.

### BRIEF DESCRIPTION OF THE DRAWINGS

FIG. 1A is an illustration of a wireless telephone 10 coupled to an earbud EB, which is an example of a personal audio device in which the techniques disclosed herein can be implemented.

FIG. 1B is an illustration of electrical and acoustical signal paths in FIG. 1A.

FIG. 2 is a block diagram of circuits within wireless telephone 10 and/or earbud EB of FIG. 1A.

FIG. 3 is a block diagram depicting signal processing circuits and functional blocks within ANC circuit 30 of CODEC integrated circuit 20 of FIG. 2 in accordance with an embodiment of the present invention.

FIG. 4 is a block diagram depicting signal processing circuits and functional blocks within an integrated circuit in accordance with an embodiment of the present invention.

### DESCRIPTION OF ILLUSTRATIVE EMBODIMENT

The present invention encompasses noise canceling techniques and circuits that can be implemented in a personal audio system, such as a wireless telephone and connected earbuds. The personal audio system includes an adaptive noise canceling (ANC) circuit that measures the ambient acoustic environment at the earbuds or other output transducer and generates a signal that is injected in the speaker (or other transducer) output to cancel ambient acoustic events. A reference microphone is provided to measure the ambient acoustic environment, which is used to generate an anti-noise signal provided to the speaker to cancel the ambient audio sounds. A model of a leakage path from the speaker output to the reference microphone input is also implemented by the ANC circuit so that the source audio and /or the anti-noise signal reproduced by the transducer can be removed from the reference microphone signal. The leakage path audio is implemented so that the ANC circuit does not try to adapt to and cancel the source audio and anti-noise signal, or otherwise become disrupted by leakage.

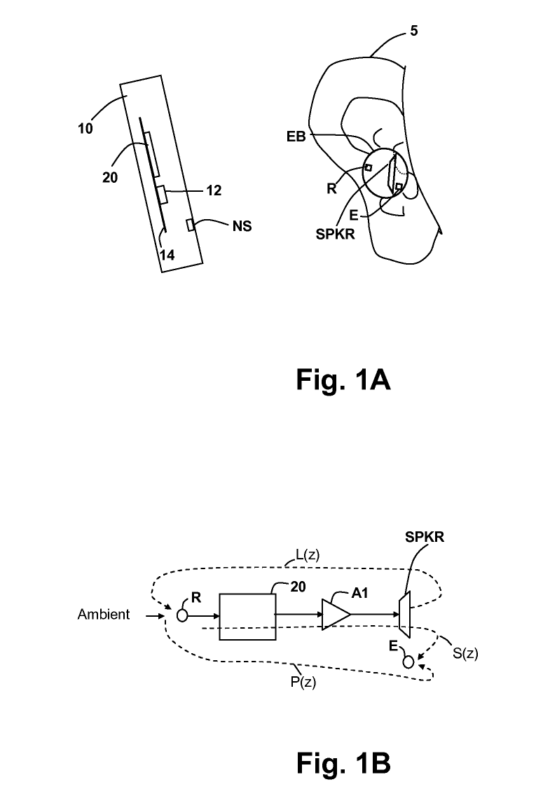

FIG. 1A shows a wireless telephone 10 proximity to a human ear 5. Illustrated wireless telephone 10 is an example of a device in which the techniques herein may be employed, but it is understood that not all of the elements or configurations illustrated in wireless telephone 10, or in the circuits depicted in subsequent illustrations, are required. Wireless telephone 10 is connected to an earbud EB by a wired or wireless connection, e.g., a BLUETOOTH™ connection (BLUETOOTH is a trademark or Bluetooth SIG, Inc.). Earbud EB has a transducer, such as speaker SPKR, which reproduces source audio including distant speech received from wireless telephone 10, ringtones, stored audio program material, and injection of near-end speech (i.e., the speech of the user of wireless telephone 10). The source audio also includes any other audio that wireless telephone 10 is required to reproduce, such as source audio from web-pages or other network communications received by wireless telephone 10 and audio indications such as battery low and other system event notifications. A reference microphone R is provided on a surface of a housing of earbud EB for measuring the ambient acoustic environment. Another microphone, error microphone E, is provided in order to further improve the ANC operation by providing a measure of the ambient audio combined with the audio reproduced by speaker SPKR close to ear 5, when earbud EB is inserted in the outer portion of ear 5. While the illustrated example shows an earspeaker implementation of a leakage path modeling noise canceling system, the techniques disclosed herein can also be implemented in a wireless telephone or other personal audio device, in which the output transducer and reference/error microphones are all provided on a housing of the wireless telephone or other personal audio device.

Wireless telephone 10 includes adaptive noise canceling (ANC) circuits and features that inject an anti-noise signal into speaker SPKR to improve intelligibility of the distant speech and other audio reproduced by speaker SPKR. Exemplary circuit 14 within wireless telephone 10 includes an audio CODEC integrated circuit 20 that receives the signals from reference microphone R, near speech microphone NS, and error microphone E and interfaces with other integrated circuits such as an RF integrated circuit 12 containing the wireless telephone transceiver. In other embodiments of the invention, the circuits and techniques disclosed herein may be incorporated in a single integrated circuit that contains control circuits and other functionality for implementing the entirety of the personal audio device, such as an MP3 player-on-a-chip integrated circuit. Alternatively, the ANC circuits may be included within a housing of earbud EB or in a module located along a wired connection between wireless telephone 10 and earbud EB. For the purposes of illustration, the ANC circuits will be described as provided within wireless telephone 10, but the above variations are understandable by a person of ordinary skill in the art and the consequent signals that are required between earbud EB, wireless telephone 10 and a third module, if required, can be easily determined for those variations. A near-speech microphone NS is provided at a housing of wireless telephone 10 to capture near-end speech, which is transmitted from wireless telephone 10 to the other conversation participant(s). Alternatively, near-speech microphone NS may be provided on the outer surface of a housing of earbud EB, or on a boom affixed to earbud EB.

FIG. 1B shows a simplified schematic diagram of an audio CODEC integrated circuit 20 that includes ANC processing, as coupled to reference microphone R, which provides a measurement of ambient audio sounds Ambient that is filtered by the ANC processing circuits within audio CODEC integrated circuit 20. Audio CODEC integrated circuit 20 generates an output that is amplified by an amplifier Al and is provided to speaker SPKR. Audio CODEC integrated circuit 20 receives the signals (wired or wireless depending on the particular configuration) from reference microphone R, near speech microphone NS and error microphone E and interfaces with other integrated circuits such as an RF integrated circuit 12 containing the wireless telephone transceiver. In other configurations, the circuits and techniques disclosed herein may be incorporated in a single integrated circuit that contains control circuits and other functionality for implementing the entirety of the personal audio device, such as an MP3 player-on-a-chip integrated circuit. Alternatively, multiple integrated circuits may be used, for example, when a wireless connection is provided from earbud EB to wireless telephone 10 and/or when some or all of the ANC processing is performed within earbud EB or a module disposed along a cable connecting wireless telephone 10 to earbud EB.

In general, the ANC techniques illustrated herein measure ambient acoustic events (as opposed to the output of speaker SPKR and/or the near-end speech) impinging on reference microphone R, and also measure the same ambient acoustic events impinging on error microphone E. The ANC processing circuits of illustrated wireless telephone 10 adapt an anti-noise signal generated from the output of reference microphone R to have a characteristic that minimizes the amplitude of the ambient acoustic events at error microphone E. Since acoustic path P(z) extends from reference microphone R to error microphone E, the ANC circuits are essentially estimating acoustic path P(z) combined with removing effects of an electro-acoustic path S(z) that represents the response of the audio output circuits of CODEC IC 20 and the acoustic/electric transfer function of speaker SPKR. The estimated response includes the coupling between speaker SPKR and error microphone E in the particular acoustic environment which is affected by the proximity and structure of ear 5 and other physical objects and human head structures that may be in proximity to earbud EB. Leakage, i.e., acoustic coupling, between speaker SPKR and reference microphone R can cause error in the anti-noise signal generated by the ANC circuits within CODEC IC 20. In particular, desired downlink speech and other internal audio intended for reproduction by speaker SPKR can be partially canceled due to the leakage path L(z) between speaker SPKR and reference microphone R. Since audio measured by reference microphone R is considered to be ambient audio that generally should be canceled, leakage path L(z) represents the portion of the downlink speech and other internal audio that is present in the reference microphone signal and causes the above-described erroneous operation. Therefore, the ANC circuits within CODEC IC 20 include leakage-path modeling circuits that compensate for the presence of leakage path L(z). While the illustrated wireless telephone 10 includes a two microphone ANC system with a third near speech microphone NS, a system may be constructed that does not include separate error and reference microphones. Alternatively, when near speech microphone NS is located proximate to speaker SPKR and error microphone E, near-speech microphone NS may be used to perform the function of the reference microphone R. Also, in personal audio devices designed only for audio playback, near speech microphone NS will generally not be included, and the near-speech signal paths in the circuits described in further detail below can be omitted.

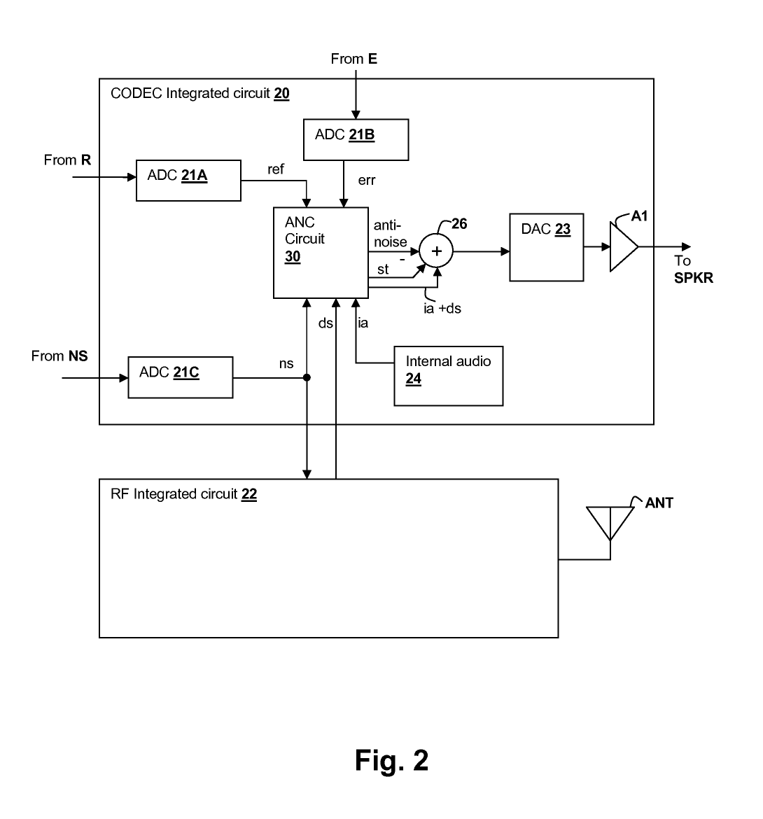

Referring now to FIG. 2, circuits within wireless telephone 10 are shown in a block diagram. The circuit shown in FIG. 2 further applies to the other configurations mentioned above, except that signaling between CODEC integrated circuit 20 and other units within wireless telephone 10 are provided by cables or wireless connections when CODEC integrated circuit 20 is located outside of wireless telephone 10. In such a configuration, signaling between CODEC integrated circuit 20 and error microphone E, reference microphone R and speaker SPKR are provided by wired or wireless connections when CODEC integrated circuit 20 is located within wireless telephone 10. CODEC integrated circuit 20 includes an analog-to-digital converter (ADC) 21A for receiving the reference microphone signal and generating a digital representation ref of the reference microphone signal. CODEC integrated circuit 20 also includes an ADC 21B for receiving the error microphone signal and generating a digital representation err of the error microphone signal, and an ADC 21C for receiving the near speech microphone signal and generating a digital representation ns of the error microphone signal. CODEC IC 20 generates an output for driving speaker SPKR from an amplifier A1, which amplifies the output of a digital-to-analog converter (DAC) 23 that receives the output of a combiner 26. Combiner 26 combines audio signals is from internal audio sources 24, and the anti-noise signal anti-noise generated by ANC circuit 30, which by convention has the same polarity as the noise in reference microphone signal ref and is therefore subtracted by combiner 26. Combiner 26 also combines an attenuated portion of near speech signal ns, i.e., sidetone information st, so that the user of wireless telephone 10 hears their own voice in proper relation to downlink speech ds, which is received from radio frequency (RF) integrated circuit 22. Near speech signal ns is also provided to RF integrated circuit 22 and is transmitted as uplink speech to the service provider via antenna ANT.

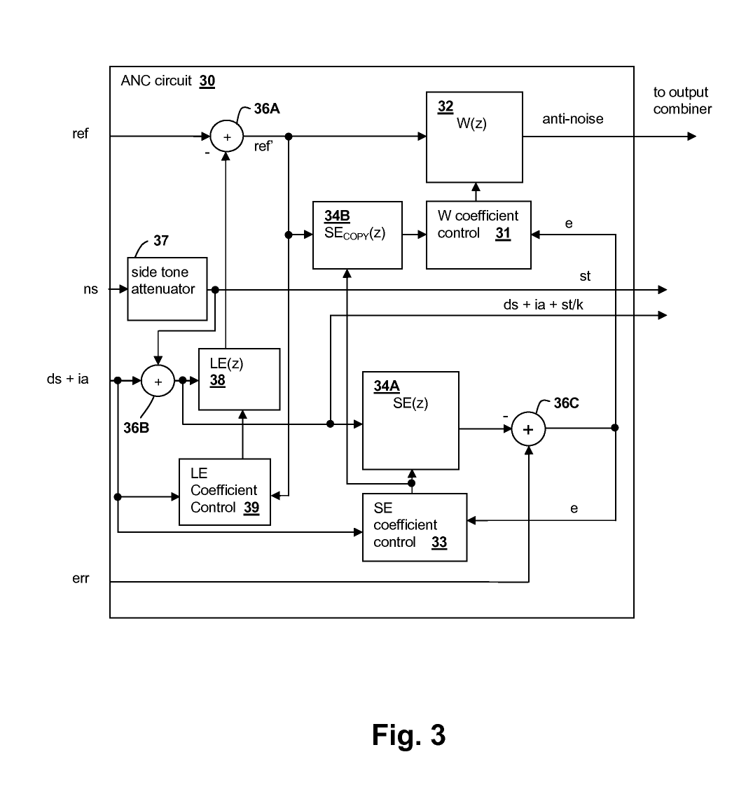

Referring now to FIG. 3, details of ANC circuit 30 are shown. A combiner 36A removes an estimated leakage signal, which in the example is provided by a leakage-path adaptive filter 38 that models leakage path L(z), but which may be provided by a fixed filter in other configurations. Combiner 36A generates a leakage-corrected reference microphone signal ref. An adaptive filter 32 receives leakage-corrected reference microphone signal ref′ and under ideal circumstances, adapts its transfer function W(z) to be P(z)/S(z) to generate the anti-noise signal anti-noise, which is provided to an output combiner that combines the anti-noise signal with the audio to be reproduced by speaker SPKR, as exemplified by combiner 26 of FIG. 2. The coefficients of adaptive filter 32 are controlled by a W coefficient control block 31 that uses a correlation of two signals to determine the response of adaptive filter 32, which generally minimizes the error, in a least-mean squares sense, between those components of leakage-corrected reference microphone signal ref′ present in error microphone signal err. The signals processed by W coefficient control block 31 are the leakage-corrected reference microphone signal ref′ shaped by a copy of an estimate of the response of path S(z) (i.e., response SE_{COPY}(z)) provided by filter 34B and another signal that includes error microphone signal err. By transforming leakage-corrected reference microphone signal ref with a copy of the estimate of the response of path S(z), response SE_{COPY}(z), and minimizing error microphone signal err after removing components of error microphone signal err due to playback of source audio, adaptive filter 32 adapts to the desired response of P(z)/S(z).

In addition to error microphone signal err, the other signal processed along with the output of filter 34B by W coefficient control block 31 includes an inverted amount of the source audio including downlink audio signal ds, internal audio ia, and a portion of near speech signal ns attenuated by a side tone attenuator 37, which is provided from a combiner 36B. The output of combiner 36B is processed by a filter 34A having response SE(z), of which response SE_{COPY}(z) is a copy. By injecting an inverted amount of source audio and sidetone that has been filtered by response SE(z), adaptive filter 32 is prevented from adapting to the relatively large amount of source audio and the sidetone information (along with extra ambient noise information in the sidetone) present in error microphone signal err. By transforming the inverted copy of downlink audio signal ds and internal audio ia with the estimate of the response of path S(z), the source audio and sidetone that is removed from error microphone signal err before processing should match the expected version of downlink audio signal ds and internal audio ia reproduced at error microphone signal err. The source audio and sidetone amounts match because the electrical and acoustical path of S(z) is the path taken by downlink audio signal ds, internal audio ia and sidetone information to arrive at error microphone E. Filter 34B is not an adaptive filter, per se, but has an adjustable response that is tuned to match the response of adaptive filter 34A, so that the response of filter 34B tracks the adapting of adaptive filter 34A.

To implement the above, adaptive filter 34A has coefficients controlled by SE coefficient control block 33. Adaptive filter 34A processes the source audio (ds+ia) and sidetone information, to provide a signal representing the expected source audio delivered to error microphone E. Adaptive filter 34A is thereby adapted to generate a signal from downlink audio signal ds, internal audio is and sidetone information st, that when subtracted from error microphone signal err, forms an error signal e containing the content of error microphone signal err that is not due to source audio (ds+ia) and the sidetone information st. A combiner 36C removes the filtered source audio (ds+ia) and sidetone information from error microphone signal err to generate the above-described error signal e. Similarly, leakage path adaptive filter 38 processes the source audio (ds+ia) and sidetone information, to provide a signal representing the source audio delivered to reference microphone R through leakage path L(z). Leakage path adaptive filter 38 has coefficients controlled by LE coefficient control block 39 that also receives source audio (ds+ia) and the sidetone information and controls leakage path adaptive filter 38 to pass those components of source audio (ds+ia) and the sidetone information appearing in leakage-corrected reference microphone signal ref, so that those components are minimized at the input to adaptive filter 32. Alternatively, the sidetone information may be omitted from the signal introduced into leakage path adaptive filter 38.

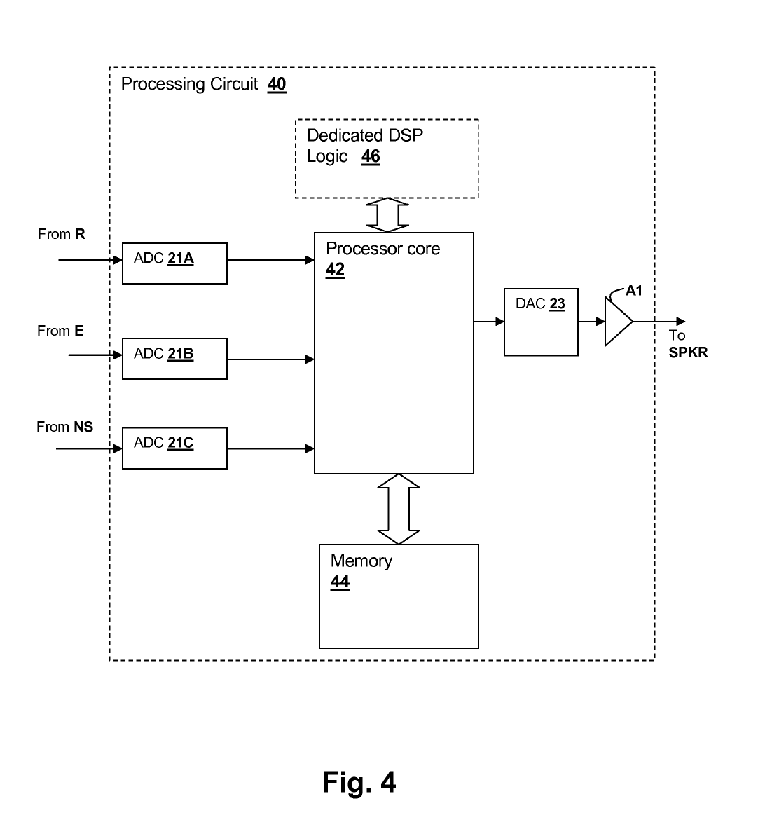

Referring now to FIG. 4, a block diagram of an ANC system is shown for implementing ANC techniques as depicted in FIG. 3, and having a processing circuit 40 as may be implemented within CODEC integrated circuit 20 of FIG. 2. Processing circuit 40 includes a processor core 42 coupled to a memory 44 in which are stored program instructions comprising a computer-program product that may implement some or all of the above-described ANC techniques, as well as other signal processing. Optionally, a dedicated digital signal processing (DSP) logic 46 may be provided to implement a portion of, or alternatively all of, the ANC signal processing provided by processing circuit 40. Processing circuit 40 also includes ADCs 21A-21C, for receiving inputs from reference microphone R, error microphone E and near speech microphone NS, respectively. In alternative embodiments in which one or more of reference microphone R, error microphone E and near speech microphone NS have digital outputs, the corresponding ones of ADCs 21A-21C are omitted and the digital microphone signal(s) are interfaced directly to processing circuit 40. DAC 23 and amplifier Al are also provided by processing circuit 40 for providing the speaker output signal, including anti-noise as described above. The speaker output signal may be a digital output signal for provision to a module that reproduces the digital output signal acoustically.

While the invention has been particularly shown and described with reference to the preferred embodiments thereof, it will be understood by those skilled in the art that the foregoing and other changes in form, and details may be made therein without departing from the spirit and scope of the invention.

What is claimed is:

1. An integrated circuit for implementing at least a portion of a personal audio device, comprising:
an output for providing an output signal to an output transducer including an anti-noise signal for countering the effects of the ambient audio sounds in an acoustic output of the output transducer;
a reference microphone input for receiving a reference microphone signal indicative of the ambient audio sounds; and
a processing circuit that adaptively generates the anti-noise signal from the reference microphone signal such that the anti-noise signal causes substantial cancellation of the ambient audio sounds, wherein the processing circuit further models an acoustic leakage path from the output transducer to the reference microphone and removes elements of the output signal appearing in the reference microphone signal due to the acoustic output of the output transducer.

2. The integrated circuit of claim 1, wherein the output signal includes both source audio for playback to a listener and the anti-noise signal.

3. The integrated circuit of claim 2, wherein the processing circuit models the acoustic leakage path by providing source audio of a predetermined characteristic as the audio signal reproduced by the output transducer and measuring a resulting response in the reference microphone signal.

4. The personal audio device of claim 3, wherein the source audio of predetermined characteristic is a noise burst.

5. The integrated circuit of claim 2, wherein the processing circuit implements an adaptive filter having a response that shapes the anti-noise signal to reduce the presence of the ambient audio sounds heard by the listener and another leakage path adaptive filter that models the acoustic leakage path dynamically.

6. The integrated circuit of claim 5, further comprising an error microphone input for receiving an error microphone signal indicative of the acoustic output of the output transducer and the ambient audio sounds at the output transducer, wherein the processing circuit further generates the anti-noise signal in conformity with an error signal, wherein the processing circuit implements a secondary path adaptive filter having a secondary path response that shapes the source audio and a combiner that, in a normal operating mode, removes the source audio from the error microphone signal to provide the error signal, wherein, in a calibration mode, the processing circuit models the acoustic leakage path by removing the source audio from the reference microphone signal to provide the error signal, wherein also in the calibration mode, the processing circuit generates the anti-noise signal from the error microphone signal, and wherein coefficients of the secondary path adaptive filter are captured during the calibration mode to provide coefficients of the leakage path adaptive filter that are subsequently applied in the normal operating mode.

7. The integrated circuit of claim 5, wherein adaptation of the leakage path adaptive filter is performed continuously except when a ratio of an amplitude of the source audio to an amplitude of the ambient audio sounds is less than a predetermined threshold.

8. The integrated circuit of claim 5, wherein the processing circuit determines that modeling of the acoustic leakage path is ineffective and, responsive to determining that the modeling of the acoustic leakage path is ineffective and determining that an amplitude of the source audio is greater than a threshold, halting adaptation of the adaptive filter that generates the anti-noise signal.

9. The integrated circuit of claim 5, wherein the processing circuit provides the anti-noise signal to a filter input of the leakage path adaptive filter.

10. The integrated circuit of claim 5, wherein the processing circuit provides the source audio to a filter input of the leakage path adaptive filter.

11. The integrated circuit of claim 5, wherein the source audio includes sidetone information generated from a near speech microphone.

12. The integrated circuit of claim 5, wherein the processing circuit provides the anti-noise signal combined with the source audio to a filter input of the leakage path adaptive filter.

13. A method of countering effects of ambient audio sounds by a personal audio device, the method comprising:
measuring ambient audio sounds with a reference microphone to produce a reference microphone signal;
adaptively generating an anti-noise signal from the reference microphone signal for countering the effects of ambient audio sounds in an acoustic output of a transducer;
providing the anti-noise signal to the transducer;
modeling an acoustic leakage path from the output transducer to the reference microphone; and
removing elements of the output signal appearing in the result of the measuring due to the acoustic output of the output transducer.

14. The method of claim 13, further comprising combining the anti-noise signal with source audio.

15. The method of claim 14, wherein the modeling of the acoustic leakage path comprises:
providing source audio of predetermined characteristic as a portion of an audio signal reproduced by the output transducer; and
measuring a resulting response to the providing in the reference microphone signal.

16. The method of claim 15, wherein the source audio of predetermined characteristic is a noise burst.

17. The method of claim 14, further comprising:
shaping the anti-noise with an adaptive filter to reduce the presence of the ambient audio sounds heard by the listener; and
modeling the acoustic leakage path dynamically with a leakage path adaptive filter.

18. The method of claim 17, further comprising:
measuring the acoustic output of the transducer with an error microphone, wherein the adaptively generating implements an adaptive filter having a response that frequency-shapes the anti-noise signal to reduce the presence of the ambient audio sounds in the result of the measuring the acoustic output of the transducer in conformity with an error signal;
in a normal operating mode, removing the source audio from the error microphone signal to generate the error signal and modeling the acoustic leakage path by removing the source audio from the reference microphone signal to provide the error signal;
in a calibration mode, removing the source audio from the reference microphone signal, generating the anti-noise signal from the error microphone signal, and capturing coefficients of the secondary path adaptive filter to provide coefficients of the leakage path adaptive filter; and
in the normal operating mode, subsequently applying the captured coefficients in the modeling of the acoustic leakage path by the leakage path adaptive filter.

19. The method of claim 17, wherein the modeling of the acoustic leakage path adapts the leakage path adaptive filter continuously except when a ratio of an amplitude of the source audio to an amplitude of the ambient audio sounds is less than a predetermined threshold.

20. The method of claim 17, wherein the determining comprises modeling of the acoustic leakage path is ineffective and, responsive to the determining that the modeling of the acoustic leakage path is ineffective and determining that an amplitude of the source audio is greater than a threshold, halting adaptation of the adaptive filter that generates the anti-noise signal.

21. The method of claim 17, further comprising providing the anti-noise signal to a filter input of the leakage path adaptive filter.

22. The method of claim 17, further comprising providing the source audio to a filter input of the leakage path adaptive filter.

23. The method of claim 17, wherein the source audio includes sidetone information generated from a near speech microphone.

24. The method of claim 17, further comprising providing the anti-noise signal combined with the source audio to a filter input of the leakage path adaptive filter.

25. A personal audio device, comprising:
a personal audio device housing;
a transducer mounted on the housing for reproducing an audio signal including an anti-noise signal for countering effects of ambient audio sounds in an acoustic output of the output transducer;
a reference microphone mounted on the housing for providing a reference microphone signal indicative of the ambient audio sounds; and
a processing circuit within the housing that adaptively generates the anti-noise signal from the reference microphone signal such that the anti-noise signal causes substantial cancellation of the ambient audio sounds, wherein the processing circuit further models an acoustic leakage path from the output transducer to the reference microphone and removes elements of the output signal appearing in the reference microphone signal due to the acoustic output of the output transducer.

26. The personal audio device of claim 25 wherein the output signal includes both source audio for playback to a listener and the anti-noise signal.

27. The personal audio device of claim 26, wherein the processing circuit models the acoustic leakage path by providing source audio of a predetermined characteristic as the audio signal reproduced by the output transducer and measuring a resulting response in the reference microphone signal.

28. The personal audio device of claim 27, wherein the source audio of predetermined characteristic is a noise burst.

29. The personal audio device of claim 27, wherein the processing circuit implements an adaptive filter having a response that shapes the anti-noise signal to reduce the presence of the ambient audio sounds heard by the listener and another leakage path adaptive filter that models the acoustic leakage path dynamically.

30. The personal audio device of claim 29, further comprising an error microphone mounted on the housing that generates an error microphone signal indicative of the acoustic output of the output transducer and the ambient audio sounds at the output transducer, wherein the processing circuit further generates the anti-noise signal in conformity with an error signal, wherein the processing circuit implements a secondary path adaptive filter having a secondary path response that shapes the source audio and a combiner that, in a normal operating mode, removes the source audio from the error microphone signal to provide the error signal, wherein, in a calibration mode, the processing circuit models the acoustic leakage path by removing the source audio from the reference microphone signal to provide the error signal, wherein also in the calibration mode, the processing circuit generates the anti-noise signal from the error microphone signal, and wherein coefficients of the secondary path adaptive filter are captured during the calibration mode to provide coefficients of the leakage path adaptive filter that are subsequently applied in the normal operating mode.

31. The personal audio device of claim 29, wherein adaptation of the leakage path is performed continuously except when a ratio of an amplitude of the source audio to an amplitude of the ambient audio sounds is less than a predetermined threshold.

32. The personal audio device of claim 29, wherein the processing circuit determines that modeling of the acoustic leakage path is ineffective and, responsive to determining that the modeling of the acoustic leakage path is ineffective and determining that an amplitude of the source audio is greater than a threshold, halting adaptation of the adaptive filter that generates the anti-noise signal.

33. The personal audio device of claim 29, wherein the processing circuit provides the anti-noise signal to a filter input of the leakage path adaptive filter.

34. The personal audio device of claim 29, wherein the processing circuit provides the source audio to a filter input of the leakage path adaptive filter.

35. The personal audio device of claim 29, wherein the source audio includes sidetone information generated from a near speech microphone mounted on the housing.

36. The personal audio device of claim 29, wherein the processing circuit provides the anti-noise signal combined with the source audio to a filter input of the leakage path adaptive filter.
